(19) United States
(12) Patent Application Publication
(10) Pub. No.: US 2022/0151038 A1
(43) Pub. Date: May 12, 2022

(54) DIMMING UNIT ARRANGED FOR DIMMING A LIGHT EMITTING DIODE, LED, BASED LIGHTING DEVICE AS WELL AS A CORRESPONDING METHOD

(71) Applicant: KLEMKO TECHNIEK B.V., SOEST (NL)

(72) Inventors: Adrianus Jacobus KLAVER, SOEST (NL); Petrus VAN ROSSUM, SOEST (NL)

(21) Appl. No.: 17/440,558

(22) PCT Filed: Mar. 19, 2020
(86) PCT No.: PCT/NL2020/050184

§ 371 Date: Sep. 17, 2021

(30) Foreign Application Priority Data
Mar. 20, 2019 (NL) 2022772

(51) Int. Cl. H05B 45/14; H05B 47/19

(52) U.S. Cl. CPC H05B 45/14; H05B 47/19

(57) ABSTRACT

A dimming unit arranged for dimming a Light Emitting Diode, LED, based lighting device, wherein said dimming unit comprises a switch arranged for receiving an Alternating Current, AC, mains signal and for providing a supply signal to said LED based lighting device based on a switch control signal, a controller arranged for providing said switch control signal, and comprising a lookup table comprising a relationship between a current range of a preconfigured LED based lighting device and a brightness range of said preconfigured LED based lighting device, a dimmer arranged for providing a dimming level to said controller based on an input dimming range, wherein said controller is further arranged for translating said dimming level to said switch control signal such that said brightness range is linear to said input dimming range using said lookup table.

### SUMMARY

The present disclosure is related to a dimming unit arranged for dimming a Light Emitting Diode, LED, based lighting device.

LED based lighting devices have been developed for a variety of lighting applications. Owing to their long lifetime and high energy efficiency, LED lamps are nowadays more popular compared to conventional lighting techniques. A dimming unit is arranged to dim the output of a LED based lighting device.

One of the downsides of known dimming units is that they are not able to dim a LED based lighting device in such a way that it is perceived as pleasant for a user.

It is therefor an object of the present disclosure to provide for a dimming unit arranged for dimming a Light Emitting Diode, LED, based lighting device such that it is perceived as pleasant for a user.

In a first aspect, there is provided a dimming unit arranged for dimming a Light Emitting Diode, LED, based lighting device, wherein said dimming unit comprises:
a switch arranged for receiving an Alternating Current, AC, mains signal and for providing a supply signal to said LED based lighting device based on a switch control signal;
a controller arranged for providing said switch control signal, and comprising a lookup table comprising a relationship between a current range of a preconfigured LED based lighting device and a brightness range of said preconfigured LED based lighting device;
a dimmer arranged for providing a dimming level to said controller based on an input dimming range;

wherein said controller is further arranged for translating said dimming level to said switch control signal such that said brightness range is linear to said input dimming range using said lookup table.

It is noted that the dimming unit may not be placed, or mounted, at the same place where the LED based lighting device is mounted. Typically, the dimming unit is mounted in a wall installation box of a home wiring system while the LED based lighting device is mounted on the ceiling of a room. The dimming unit may then activate, and dim, the LED based lighting device.

The switch is arranged for receiving an Alternating Current, AC, mains signal and for providing a supply signal to said LED based lighting device based on a switch control signal. Such a switch may, for example, be a Metal Oxide Semiconductor, MOS, Field Effect Transistor, FET, MOSFET, a power transistor or anything alike. Typically, the switch control signal is a Pulse Width Modulation, PWM, signal having a particular duty cycle. The duty cycle represents, or is correlated, to the dimming signal that is set for the LED based lighting device.

The controller is arranged for providing the switch control signal, and comprises a lookup table comprising a relationship between a current range of a preconfigured LED based lighting device and a brightness range of said preconfigured LED based lighting device.

Such a controller may be implemented as a microcontroller, an Application Specific Integrated Controller, ASIC, an Field Programmable Gate Array, FPGA, analogue or digital electronic circuitry, or anything alike. It is noted that the dimming unit may further comprise a power supply which is arranged for receiving the AC mains signal, and for converting the AC mains signal to a low voltage Direct Current, DC, voltage. The DC voltage may be used to empower the controller.

The lookup table may be stored in a register, in a memory, in a cache or anything alike. The lookup table is thus arranged to provide for a translation of the current range of a preconfigured LED based lighting device and a brightness range of the preconfigured LED based lighting device.

Finally, a dimmer is provided which is arranged for providing a dimming level to said controller based on an input dimming range. The dimmer is, for example, a potentiometer or anything a like. It is noted that a user may use the dimmer for providing its input with respect to the desired dimming level of the LED based lighting device. The dimmer may provide a dimming level that translated to an input dimming range.

One of the aspects of the present disclosure is that the is further arranged for translating said dimming level to said switch control signal such that said brightness range is linear to said input dimming range using said lookup table.

This entails that a perceived linear increase in the dimming level corresponds to a perceived linear increase in the brightness of the LED based lighting device, and that a perceived linear decrease in the dimming level corresponds to a perceived linear decrease in the brightness of the LED based lighting device.

It is noted that, initially, the lookup table comprises data with respect to a preconfigured LED based lighting device. As such, the dimmer assumes that the values set for the current range of the preconfigured LED based lighting device are also valid for the actual LED based lighting device to which the dimming unit connects.

In an example, the controller is further arranged for measuring a current of said supply signal to said LED based lighting device,

wherein said controller is arranged for calibrating said translating by measuring said current of said supply signal over said full input dimming range.

In order to improve the translation part of the presented method, a calibration step may be performed. The calibration step is performed to enlighten the controller over the full input dimming range of the dimmer. This allows the controller to determine a translation mechanism that is adequate over the full range of the input dimming range. The translation mechanism then ensures that the input dimming range translates linearly to the brightness level of the LED based lighting device.

In a further example, the said dimming unit further comprises a minimum threshold setter for setting a minimum threshold of said dimming level of said dimmer.

It is noted that the LED based lighting device is typically arranged to provide its full output, i.e. a maximum setting of the brightness, once the dimmer is set to the maximum input dimming range. However, it may be beneficial to have a dead zone, i.e. a particular sub range within the input dimming range, that does not contribute to the light output. As such, once a user has set a dimming level to above that particular minimum threshold, the controller will start with the translating process. As such, the controller will act as if the effective input dimming range is in fact compensated for the dead zone, i.e. the sub range.

In a further example, the said controller comprises wireless receiving means for wirelessly receiving said dimming level from said dimmer.

The controller may, for example, be equipped with a WiFi transceiver, a Bluetooth receiver or transceiver, a Zigbee receiver or transceiver, or anything alike. Instead of a user manually, directly, inputting the dimming level into the controller, it may also be input via wireless means, for example via a mobile phone or anything alike. The controller may thus comprise wireless receiving means for connecting to a further wireless device, which further wireless device is arranged to transmit the dimming range to the controller.

In another example, the dimming unit further comprises a mobile User Equipment, UE, which mobile UE comprises said dimmer, and wherein said UE comprises wireless transmitting means arranged for wirelessly transmitting said dimming level to said wireless receiving means of said controller.

The mobile UE may, for example, comprise a smart phone, a tablet, a desktop computer, a laptop or anything alike. Such a mobile UE may be equipped with an “app”, which app is arranged to receive input from a user with respect to the dimming level that is to be set for a LED based lighting device. The app may, for example, visualize a slider, which the user is able to manipulate from a minimum dimming level to a maximum dimming level.

In yet another example, the receiving means are further arranged for wirelessly receiving any of:
said lookup table of adjusting said relationship to a certain LED based lighting device;
a relationship between a current range of a preconfigured LED based lighting device and a brightness range of said preconfigured LED based lighting device for incorporating in said lookup table for adjusting said relationship to a certain LED based lighting device.

It may be beneficial if the controller is able to receive the data with respect to the current range of the actual LED based lighting device which is to be controlled by the dimming unit. This makes the translating part of the present disclosure more accurate. In stead of using “standard” values for the current range of the preconfigured LED based lighting device, tailored values of the current range may be used, which tailored values are tailored to the actual LED based lighting device. The user may, for example, indicate, using an app on a mobile User Equipment, UE, which LED based lighting device is used, and the app may retrieve the relevant current ranges, or brightness levels, based on the indications provided by the user.

In a further example, the said dimmer comprises a potentiometer arranged to be set by a user. A potentiometer is a three-terminal resistor with a sliding or rotating contact, that can be manipulated by a user, that forms an adjustable voltage divider. If only two terminals are used, one end and the wiper, it acts as a variable resistor or rheostat. Both options are viable in the context of the present disclosure.

In a second aspect, there is provided a Light Emitting Diode, LED, based lighting device assembly, comprising:
a dimming unit in accordance with any of the previous claims, and
a LED based lighting device connected to said switch.

It is noted that the advantages and definitions as disclosed with respect to the examples of the first aspect of the invention also corresponds to the examples of the second aspect of the invention, being the LED based lighting device assembly.

In a third aspect, there is provided a method for operating a dimming unit in accordance with any of the examples as provided above, wherein said method comprises the steps of:
receiving, by said switch, said AC mains signals and providing said supply signal to said LED based lighting device based on said switch control signal;
receiving, by said controller, from said dimmer, said dimming level based on said input dimming range;
providing, by said controller, said switch control signal to said switch by translating said dimming level to said switch control signal such that said brightness range is linear to said input dimming range using said lookup table.

It is noted that the advantages and definitions as disclosed with respect to the examples of the first aspect of the invention also corresponds to the examples of the third aspect of the invention, being the method for operating a dimming unit.

In an example, the controller is further arranged for measuring a current of said supply signal to said LED based lighting device, wherein said method further comprises the step of:
calibrating said translating by measuring said current of said supply signal over said full input dimming range.

In a further example, said dimming unit further comprises a minimum threshold setter for setting a minimum threshold of said dimming level of said dimmer, wherein said method further comprises the step of:
setting, by said minimum threshold setter, said minimum threshold of said dimming level.

In another example, the controller comprises wireless receiving means for wirelessly receiving said dimming level from said dimmer, and wherein said method further comprises the step of:
receiving, by said wireless receiving means, said dimming level from said dimmer.

In an example, the dimming unit further comprises a mobile User Equipment, UE, which mobile UE comprises said dimmer, and wherein said UE comprises wireless transmitting means, wherein said method further comprises the step of:
wirelessly transmitting, by said wireless transmitting means, said dimming level to wireless receiving means comprised by said controller.

In yet another example, the receiving means are further arranged for wirelessly receiving any of:
said lookup table of adjusting said relationship to a certain LED based lighting device;
a relationship between a current range of a preconfigured LED based lighting device and a brightness range of said preconfigured LED based lighting device for incorporating in said lookup table for adjusting said relationship to a certain LED based lighting device.

In a fourth aspect, there is provided a computer program product comprising computer readable medium having instructions stored thereon which, when executed by a dimming unit, cause said dimming unit to implement a method in accordance with any of the examples as provided above.

The present disclosure will now be explained by means of a description of a dimming unit in accordance to the first aspect of the present disclosure and a method of operating such a dimming unit in accordance with the third aspect of the present disclosure, in which reference is made to the following schematic figures, in which:

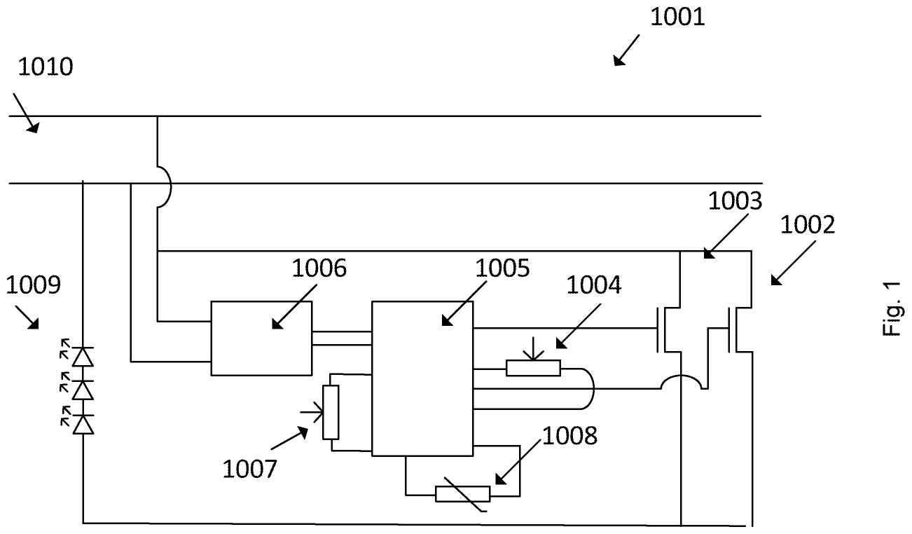

FIG. 1 discloses a schematic diagram of an electric circuit illustrating components comprised by the dimming unit;

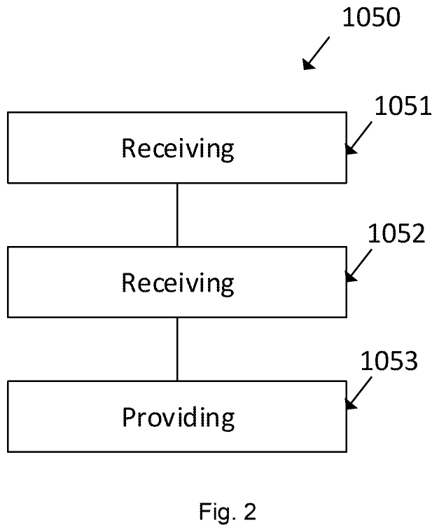

FIG. 2 discloses a schematic flow diagram of a method of operating a dimming unit in accordance with the present disclosure.

FIG. 1 discloses a schematic diagram 1001 of an electric circuit illustrating components comprised by the dimming unit. In accordance with the present disclosure, the dimming unit may comprise a plurality of components.

In this particular example, the dimming unit comprises two switches as indicated with reference numerals 1002 and 1003. A first 1002 of the switches is arranged for allowing a positive half of the received Alternating Current, AC, mains signal to pass to the LED based lighting device 1009, and a second 1003 of the switches is arranged for allowing a negative half of the received AC mains signal to pass to the LED based lighting device 1009. The switches are controlled based on a switch control signals, which switch control signals are fed to the gates of the switches.

In this particular scenario, the switches 1002, 1003 are power Metal Oxide Semiconductor, MOS, Field Effect Transistors, FETS. It may be noted that the switches may also comprise transistors, relays, or anything alike.

A controller 1005 is provided in the form of a block. The controller 1005 may, for example, be an Integrated Controller, IC, an Application Specific IC, ASIC, a Field Programmable Gate Array, FPGA, analogue electronica, or anything alike.

The controller 1005 comprises a lookup table comprising a relationship between a current range of a preconfigured LED based lighting device 1009 and a brightness range of said preconfigured LED based lighting device 1009. The lookup table may thus comprises a particular brightness, for example Lumen, for a particular current that flows through the LED based lighting device 1009.

The dimming unit 1001 may further comprise a dimmer 1004 arranged for providing a dimming level to said controller 1005 based on an input dimming range.

The dimmer 1004 is, for example, a potentiometer. The potentiometer has a sliding or rotating contact which the user is able to manipulate to select the desired dimming range.

The controller 1005 is arranged for translating said dimming level to said switch control signal such that said brightness range is linear to said input dimming range using said lookup table. The end result is thus that the user perceives as if the brightness that originates from the LED based lighting device 1009 is linearly depending on the input dimming range.

The switch control signals, provided by the controller 1005, may be a PWM signal, i.e. a Pulse Width Modulation, signal. The PWM signal to the first switch may be inverted compared to the PWM signal to the second switch.

Further, a power unit 1006 is provided for converting the AC mains supply 1010 a low voltage power for empowering the controller 1005. The power unit 1006 may comprise a switched power supply or a transformer or anything alike.

It is noted that the controller may further be arranged for measuring a current of said supply signal to said LED based lighting device and/or wherein said controller is arranged for calibrating said translating by measuring said current of said supply signal over said full input dimming range. The current flowing to the LED based lighting device 1009 may be measured using a low Ohmic resistor in the current path to the LED based lighting device.

The dimming unit 1001 may further comprise a minimum threshold setter 1007, for example also a potentiometer, for setting a minimum threshold of said dimming level of said dimmer.

Finally, a safety mechanism may be provided in the form of a Negative Temperature Coefficient, NTC, resistor 1008. The resistor may indicate to the controller 1005 if the temperature rises too high. That particular input may be used by the controller to shut things down, or to take other adequate measures.

FIG. 2 discloses a schematic flow diagram of a method 1050 of operating a dimming unit in accordance with the present disclosure.

The method 1050 is directed to operating a dimming unit in accordance with any of the examples as provided above, wherein said method comprises the steps of:
receiving 1051, by said switch, said AC mains signals and providing said supply signal to said LED based lighting device based on said switch control signal;
receiving 1052, by said controller, from said dimmer, said dimming level based on said input dimming range;
providing 1053, by said controller, said switch control signal to said switch by translating said dimming level to said switch control signal such that said brightness range is linear to said input dimming range using said lookup table.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article, “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an Any reference signs in the claims should not be construed as limiting the scope thereof.

1-15. (canceled)

16. A dimming unit configured for dimming a Light Emitting Diode (LED) based lighting device, the dimming unit comprising:
a switch configured to receive an Alternating Current (AC) main signal and provide a supply signal to the LED based lighting device based on a switch control signal;
a controller configured to provide the switch control signal, and comprising a lookup table comprising a relationship between a current range of a preconfigured LED based lighting device and a brightness range of the preconfigured LED based lighting device; and
a dimmer configured to provide a dimming level to the controller based on an input dimming range;
wherein the controller is further configured to translate the dimming level to the switch control signal such that the brightness range is linear to the input dimming range using the lookup table.

17. The dimming unit according to claim 16, wherein the controller is further configured to measure a current of the supply signal to the LED based lighting device,
wherein the controller is configured to calibrate the translating by measuring the current of the supply signal over the full input dimming range.

18. The dimming unit according to claim 16, wherein the dimming unit further comprises a minimum threshold setter for setting a minimum threshold of the dimming level of the dimmer.

19. The dimming unit according to claim 16, wherein the controller comprises a wireless receiver for wirelessly receiving the dimming level from the dimmer.

20. The dimming unit according to claim 19, wherein the dimming unit further comprises a mobile User Equipment (UE), wherein the mobile UE comprises the dimmer, and wherein the mobile UE comprises a wireless transmitter for wirelessly transmitting the dimming level to the wireless receiver of the controller.

21. The dimming unit according to claim 19, wherein the wireless receiver is configured to receive wirelessly at least one of:
the lookup table for adjusting the relationship to a predetermined LED based lighting device; and
a relationship between a current range of a preconfigured LED based lighting device and a brightness range of the preconfigured LED based lighting device for incorporating in the lookup table for adjusting the relationship to a predetermined LED based lighting device.

22. The dimming unit according to claim 16, wherein the dimmer comprises a potentiometer configured to be set by a user.

23. A Light Emitting Diode (LED) based lighting device assembly, comprising:
a dimming unit according to claim 16; and
an LED based lighting device connected to the switch.

24. A method for operating the dimming unit according to claim 16, comprising the steps of:
receiving, by the switch, the AC main signals and providing the supply signal to the LED based lighting device based on the switch control signal;
receiving, by the controller, from the dimmer, the dimming level based on the input dimming range; and
providing, by the controller, the switch control signal to the switch by translating the dimming level to the switch control signal such that the brightness range is linear to the input dimming range using the lookup table.

25. The method according to claim 24, wherein the controller is further configured to measure a current of the supply signal to the LED based lighting device; and
wherein the method further comprises the step of calibrating the translating by measuring the current of the supply signal over the full input dimming range.

26. The method according to claim 24, wherein the dimming unit further comprises a minimum threshold setter for setting a minimum threshold of the dimming level of the dimmer; and
wherein the method further comprises the step of setting, by the minimum threshold setter, the minimum threshold of the dimming level.

27. The method according to claim 24, wherein the controller comprises a wireless receiver for wirelessly receiving the dimming level from the dimmer; and
wherein the method further comprises the step of receiving, by the wireless receiver, the dimming level from the dimmer.

28. The method according to claim 24, wherein the dimming unit further comprises a mobile User Equipment (UE), wherein the mobile UE comprises the dimmer, and wherein the mobile UE comprises a wireless transmitter; and
wherein the method further comprises the step of wirelessly transmitting, by the wireless transmitter, the dimming level to the wireless receiver means of the controller.

29. The method according to claim 27, wherein the wireless receiver is configured to receive wirelessly at least one of:
the lookup table for adjusting the relationship to a certain LED based lighting device; and
a relationship between a current range of a preconfigured LED based lighting device and a brightness range of the preconfigured LED based lighting device for incorporating in the lookup table for adjusting the relationship to a predetermined LED based lighting device.

30. A computer program product comprising computer readable medium having instructions stored thereon which, when executed by a dimming unit, cause the dimming unit to implement a method according to claim 24.
